(19) United States
(12) Patent Application Publication
(10) Pub. No.: US 2019/0265910 A1
(43) Pub. Date: Aug. 29, 2019

(54) MEMORY SYSTEM

(71) Applicant: TOSHIBA MEMORY CORPORATION, Tokyo (JP)

(72) Inventors: Yukiko TOYOOKA, Yokohama Kanagawa (JP); Tomoyuki KANTANI, Fujisawa Kanagawa (JP); Kousuke FUJITA, Yokohama Kanagawa (JP); Takashi OGASAWARA, Fujisawa Kanagawa (JP)

(21) Appl. No.: 16/165,876

(22) Filed: Oct. 19, 2018

(30) Foreign Application Priority Data
Feb. 26, 2018 (JP) 2018-032322

(51) Int. Cl. G06F 3/06

(52) U.S. Cl. CPC G06F 3/0659; G06F 3/0679; G06F 3/0604

(57) ABSTRACT

A memory system connectable to a host includes a nonvolatile memory that includes a plurality of blocks, and a controller that is electrically connected to the nonvolatile memory. The controller is configured to determine whether or not write data received from the host has system data characteristics based on tag information received from the host along with the write data, and to write first write data designated as data having the system data characteristics according to the received tag information into a first block for writing first type data having a first level update frequency, and write second write data not designated as data having the system data characteristics according to the received tag information into a second block for writing second type data having a second level update frequency lower than the first level update frequency.

### CROSS-REFERENCE TO RELATED APPLICATIONS

This application is based upon and claims the benefit of priority from Japanese Patent Application No. 2018-032322, filed Feb. 26, 2018, the entire contents of which are incorporated herein by reference.

### FIELD

Embodiments described herein relate generally to a technology for controlling a nonvolatile memory.

### BACKGROUND

A memory system implemented with a nonvolatile memory has recently become widespread.

As one such memory system, a flash storage device implemented with a NAND flash memory is known.

In the NAND flash memory, new data cannot be overwritten directly into an area of a block where data has already been written. Thus, in a case where data already written is updated, an operation of writing new data into an unwritten area of the block or another block and managing previous data as invalid data is executed.

Accordingly, in the NAND flash memory, the number of blocks that include invalid data increases as data is updated and as a result, fragmentation might occur in each of the blocks.

Such fragmentation reduces an amount of valid data that can be written to each block resulting in a decrease of usable storage capacity. The decrease in the usable storage capacity might increase the execution frequency of garbage collection. For this reason, the decrease in the usable storage capacity leads to a decrease in the performance of the storage device and an increase in write amplification.

### DESCRIPTION OF THE DRAWINGS

FIG. 1 is a block diagram illustrating a configuration example of an information processing system that includes a memory system according to a first embodiment.

FIG. 2 is a flowchart illustrating a procedure of determining a write destination block to which write data received from a host is to be written, based on a data size designated by a write command received from the host.

FIG. 3 is a diagram illustrating an example of an operation of selectively writing write data to a block for data having high update frequency or to a block for data having low update frequency, based on the size of the write data.

FIG. 4 is a diagram illustrating an example in which fragmentation occurs in the block for data having high update frequency.

FIG. 5 is a diagram illustrating an example in which data having high update frequency is written into the block for data having low update frequency due to a mismatch between an actual update frequency of the data and an update frequency estimated by a controller based on a determination criterion.

FIG. 6 is a diagram illustrating an example in which fragmentation occurs in the block for data having low update frequency, caused by updating the data written in the block for data having low update frequency of FIG. 5.

FIG. 7 is a diagram illustrating an example of a garbage collection operation executed on both of a block for data having high update frequency and a block for data having low update frequency.

FIG. 8 is a diagram illustrating a write command specified by a universal flash storage (UFS) standard to which the memory system according to the first embodiment may conform.

FIG. 9 is a diagram for explaining a GROUP NUMBER field included in the write command of FIG. 8.

FIG. 10 is a flowchart illustrating a procedure of a write process executed by the memory system of the first embodiment based on whether or not a system data tag having a specific value is set in the GROUP NUMBER field.

FIG. 11 is a flowchart illustrating another procedure of a write process executed by the memory system of the first embodiment based on a value of the most significant bit of the GROUP NUMBER field.

FIG. 12 is a flowchart illustrating another procedure of a write process executed by the memory system of the first embodiment based on a 5-bit value of the GROUP NUMBER field.

FIG. 13 is a diagram illustrating an operation, which is executed by the memory system of the first embodiment, of writing data having a high update frequency and a large data size into a block for data having high update frequency.

FIG. 14 is a diagram illustrating an operation of updating the data written in FIG. 13.

FIG. 15 is a diagram illustrating a garbage collection operation with respect to only a block group for data having low update frequency, which is executed by the memory system of the first embodiment.

FIG. 16 is a diagram illustrating a relationship between an active block pool, a free block pool, and two write destination blocks managed by the memory system of the first embodiment.

FIG. 17 is a flowchart illustrating a procedure of a garbage collection operation executed by the memory system of the first embodiment.

FIG. 18 is a diagram illustrating an example of a Reserved field of a write command being used as a system data tag in a memory system of a second embodiment.

FIG. 19 is a flowchart illustrating a procedure of a write process executed by the memory system of the second embodiment, based on a value stored in the Reserved field.

FIG. 20 is a diagram for explaining a DATA_TAG_SUPPORT field in an Extended Device Specific Data Register specified by an eMMC standard to which the memory system of a third embodiment may conform.

FIG. 21 is a diagram for explaining a value of the DATA_TAG_SUPPORT field of FIG. 20.

FIG. 22 is a diagram for explaining a tag request in a SET_BLOCK_COUNT command specified in the eMMC standard.

FIG. 23 is a sequence chart illustrating a procedure of a data write process executed by a host and the memory system of the third embodiment.

FIG. 24 is a flowchart illustrating a procedure of a write process executed by the memory system of the third embodiment, based on the tag request value in the SET_BLOCK_COUNT command.

FIG. 25 is a diagram illustrating a notification signal line defined in an interface that interconnects a host and a memory system of a fourth embodiment.

FIG. 26 is a flowchart illustrating a procedure of a write process executed, based on a value of the notification signal line, by the memory system of the fourth embodiment.

### DETAILED DESCRIPTION

Embodiments provide a memory system capable of improving utilization efficiency of its storage capacity.

In general, according to one embodiment, a memory system connectable to a host includes a nonvolatile memory that includes a plurality of blocks and a controller that is electrically connected to the nonvolatile memory. The controller is configured to determine whether or not write data received from the host has system data characteristics based on tag information received from the host along with the write data, and to write first write data designated as data having the system data characteristics according to the received tag information into a first block for writing first type data having a first level update frequency, and write second write data not designated as data having the system data characteristics according to the received tag information into a second block for writing second type data having a second level update frequency lower than the first level update frequency.

Hereinafter, embodiments will be described with reference to the drawings.

### First Embodiment

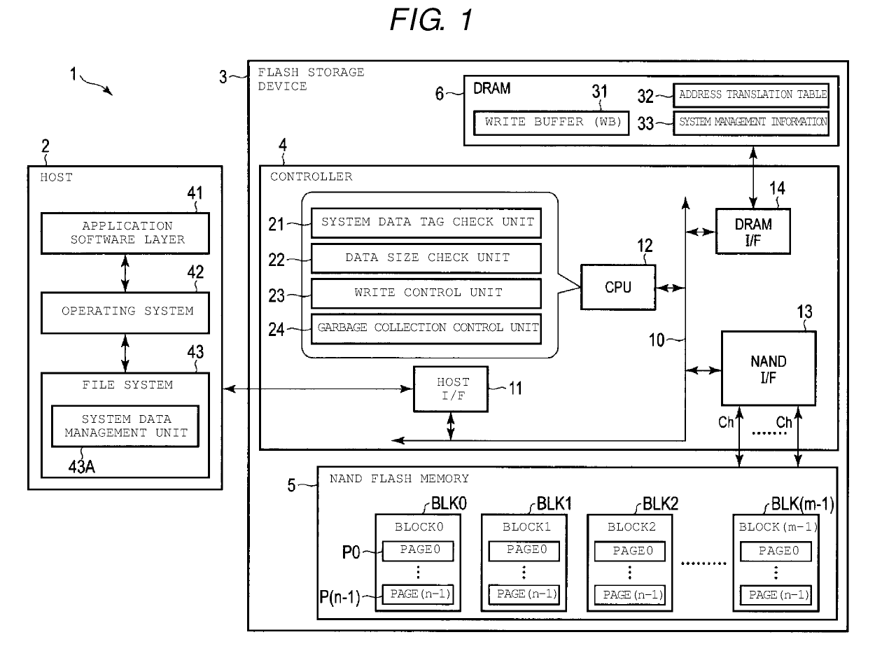

First, with reference to FIG. 1, a configuration of an information processing system 1 that includes a memory system according to a first embodiment will be described.

The memory system may be a semiconductor storage device configured to write data to a nonvolatile memory and to read data from the nonvolatile memory. This memory system is implemented, for example, as a flash storage device 3 having a NAND flash memory.

The information processing system 1 includes a host 2 and the flash storage device 3. The host 2 is an information processing apparatus that accesses the flash storage device 3. Examples of the information processing apparatus functioning as the host 2 include a personal computer, a server computer, and various electronic devices such as cellular phone, smart phone, and digital camera.

The flash storage device 3 may be used as a storage for the information processing apparatus functioning as the host 2. The flash storage device 3 may be a universal flash storage (UFS) device, an embedded multimedia card (eMMC) device, or a solid state drive (SSD).

The UFS device is a storage device conforming to the UFS standard, and is implemented as, for example, an embedded storage device or a memory card device.

The eMMC device is a storage device conforming to the eMMC standard. The eMMC device is also implemented, for example, as an embedded storage device.

In a case where the flash storage device 3 is implemented as an embedded storage device, the flash storage device 3 is integrated with the information processing apparatus. In a case where the flash storage device 3 is implemented as a card device, the flash storage device 3 is inserted into a card slot of the information processing apparatus. In a case where the flash storage device 3 is implemented as the SSD, the flash storage device 3 may be integrated with the information processing apparatus or may be connected to the information processing apparatus via a cable or a network.

As an interface for interconnecting the host 2 and the flash storage device 3, the SCSI, serial attached SCSI (SAS), ATA, serial ATA (SATA), PCI Express® (PCIe), Ethernet®, Fibre channel, NVM Express® (NVMe), universal serial bus (USB), mobile industry processor interface (MIPI), UniPro, and the like may be used.

The flash storage device 3 includes a controller 4 and a nonvolatile memory (for example, NAND flash memory) 5. The NAND flash memory 5 may include a plurality of NAND flash memory chips. The controller 4 is electrically connected to the NAND flash memory 5 and operates as a memory controller for the NAND flash memory 5. The controller 4 may be implemented by a circuit such as a system-on-a-chip (SoC).

The flash storage device 3 may also include a random access memory, for example, a DRAM 6.

The NAND flash memory 5 includes a memory cell array including a plurality of memory cells arranged in a matrix. The NAND flash memory 5 may be a NAND flash memory having a two-dimensional structure or a NAND flash memory having a three-dimensional structure.

The memory cell array of the NAND flash memory 5 includes a plurality of blocks BLK0 to BLK(m−1). Each of the blocks BLK0 to BLK(m−1) includes a plurality of pages (in this case, pages P0 to P(n−1)). The blocks BLK0 to BLK(m−1) are each erasable as a single unit. Each of the pages P0 to P(n−1) includes a plurality of memory cells connected to the same word line. The pages P0 to P(n−1) are each a unit of data write operation and data read operation.

The controller 4 can function as a flash translation layer (FTL) configured to execute data management and block management of the NAND flash memory 5. The data management executed by this FTL includes (1) management of mapping information indicating a correspondence relationship between a logical address and each physical address of the NAND flash memory 5, (2) process for concealing constraints of the NAND flash memory 5 (for example, a read/write operation is to be carried out in units of a page and an erase operation is to be carried out in units of a block), and the like. The logical address is an address used by the host 2 to designate an address of a location in a logical address space of the flash storage device 3. As the logical address, a logical block address (or addressing) (LBA) can be used.

Management of mapping between each logical address and each physical address is executed using an address translation table 32 (e.g., logical/physical address translation table). The controller 4 uses the address translation table 32 to manage the mapping between each logical address and each physical address in units of a predetermined management size. A physical address corresponding to a certain logical address indicates the latest physical storage location in the NAND flash memory 5 in which data corresponding to the logical address is written. The address translation table 32 may be loaded from the NAND flash memory 5 into the DRAM 6 when a power supply of the flash storage device 3 is turned on.

In the NAND flash memory 5, writing of data onto a page can be allowed only once per erase cycle. That is, new data cannot be overwritten directly in the area of the block where data is already written. For that reason, in a case where data already written is to be updated, the controller 4 writes new data in an unwritten area of the block or another block, and manages previous data as invalid data. In other words, the controller 4 writes updated data corresponding to a certain logical address into another physical storage location rather than the physical storage location where the previous data corresponding to the logical address is stored. Then, the controller 4 updates the address translation table 32 to associate the logical address with the different physical storage location, and invalidates the previous data.

Block management includes management of bad blocks (also referred to as defective blocks), wear leveling, garbage collection (GC), and the like. Wear leveling is an operation for leveling the number of program/erase cycles across all blocks.

The GC is an operation for increasing the number of free blocks. A free block means a block not including valid data.

In the GC, the controller 4 copies valid data in several blocks in which valid data and invalid data coexist to another block (for example, free block). Here, valid data means data associated with a certain logical address. For example, data referred to from the address translation table 32 (that is, data linked as the latest data to the certain logical address) is valid data and might be read from the host 2 later. Invalid data means data that is not associated with any logical address. Data that is not associated with any logical address is data that the host 2 will not request to read. Then, the controller 4 updates the address translation table 32, and maps each of the logical addresses of copied valid data to a physical address of a copy destination. A block from which valid data is copied to another block and thus which becomes a block to include only invalid data is released as a free block. With this, the block can be reused after an erase operation with respect to the block is executed.

The controller 4 may include a host interface 11, a CPU 12, a NAND interface 13, and a DRAM interface 14. The host interface 11, the CPU 12, the NAND interface 13, and the DRAM interface 14 may be interconnected via the bus 10.

The host interface 11 receives various commands (for example, write command, read command, unmap command (which is a SAS command or a UFS command), trim command (which is a SATA command), erase command, and various other commands) from the host 2.

The CPU 12 is a processor configured to control the host interface 11, the NAND interface 13, and the DRAM interface 14. Upon turning on of the power supply of the flash storage device 3, the CPU 12 loads a control program (e.g., firmware) stored in the NAND flash memory 5 or a ROM (not illustrated) into a volatile memory such as the DRAM 6 and executes the firmware so as to perform various processes. The CPU 12 can execute, for example, a command process for processing various commands received from the host 2, in addition to the FTL process described above. The operation of the CPU 12 is defined by the firmware executed by the CPU 12. A portion or all of the FTL processing and the command processing may be executed by hardware in the controller 4. The flash storage device 3 may be configured not to include the DRAM 6. In this case, an SRAM built in the controller 4 may be used instead of the DRAM 6.

The CPU 12 executes firmware described above to function as a system data tag check unit 21, a data size check unit 22, a write control unit 23, and a garbage collection (GC) control unit 24. The system data tag check unit 21, the data size check unit 22, the write control unit 23, and the GC control unit 24 may also be implemented by hardware in the controller 4.

The system data tag check unit 21 checks a value of a system data tag received from the host 2. The system data tag is information indicating whether or not write data to be written has system data characteristics (i.e., characteristics of system data in contrast to user data). The host 2 transmits the system data tag which is set to a specific value to the flash storage device 3 so as to make it possible to notify the flash storage device 3 that write data associated with the system data tag is data having the system data characteristics.

The type of data to be written to the flash storage device 3 by the host 2 is either user data or system data. System data is referred to as data having system data characteristics. Examples of system data include logs, file system metadata, operating system data, time stamps, and setting parameters.

The controller 4 treats write data designated as data having the system data characteristics by the system data tag as data having high update frequency. Here, an update frequency of certain data means a frequency at which the data is updated by the host. For example, the update frequency of data of a certain logical address may be represented by a frequency at which a write command designating the certain logical address is issued from the host 2.

The controller 4 determines that write data designated as data having the system data characteristics by the system data tag is data having high update frequency. Then, the controller 4 writes the write data in a block for writing data having high update frequency. The block for writing data having high update frequency means a write destination block for writing data having the high update frequency.

The controller 4 determines that write data not designated as data having the system data characteristics by the system data tag is data having low update frequency. Then, the controller 4 writes the write data into another block for writing data having low update frequency. The block for writing data having low update frequency means a write destination block for writing data having the low update frequency.

The data size check unit 22 determines whether or not a size of write data received from the host 2 is equal to or less than a threshold value. The size of the write data is designated by a write command received from the host 2.

The write control unit 23 manages two types of write destination blocks (i.e., a block for writing data having high update frequency and a block for writing data having low update frequency). The block for writing data having high update frequency is used as a block for writing first type data having first level update frequency (i.e., block for data having high update frequency). The block for writing data having low update frequency is used as a block for writing data having second level update frequency (i.e., block for data having low update frequency) lower than that of first type data.

For example, the first type data having the first level update frequency is a set of pieces of data each of which has update frequency higher than a certain threshold value, and the second type data having the second level update frequency is a set of pieces of data each of which has update frequency equal to or lower than the certain threshold value.

The write control unit 23 writes write data designated as data having the system data characteristics by the system data tag received from the host 2 into a block for data having high update frequency, and writes write data not designated as data having the system data characteristics by the system data tag received from the host 2 into a block for data having low update frequency.

The write data which is not designated as data having the system data characteristics by the system data tag is not necessarily written unconditionally into the block for data having low update frequency. For example, even if the write data is not designated as data having the system data characteristics, in a case where the write data is small data having a size equal to or less than a threshold value, the write control unit 23 may determine that the write data is data having high update frequency and write the write data to a block for data having high update frequency.

Furthermore, the write control unit 23 may write data to a block for data having high update frequency in a first program mode in which m-bit data is written per memory cell, and to a block for data having low update frequency in a second program mode in which n-bit data is written per memory cell. Here, m is an integer smaller than n. For example, m (m<n) may be an integer of one or more, or n may be an integer of two or more.

For example, the first program mode may be a single level cell (SLC) mode in which 1-bit of data is written per memory cell. The second program mode may be a multi-level cell (MLC) mode in which 2-bit of data is written per memory cell, a triple level cell (TLC) mode in which 3-bit of data is written per memory cell, or a quad-level cell (QLC) mode in which 4-bit of data is written per memory cell.

Alternatively, the first program mode may be the MLC mode and the second program mode may be the TLC mode or the QLC mode.

In a block for data having high update frequency, updated data corresponding to the same logical address is frequently written. For that reason, a block for data having high update frequency might be subjected to write/erase operation at a high frequency as compared with a block for data having low update frequency. In this case, the number of program/erase cycles of each block for data having high update frequency tends to increase. As the number of bits written per memory cell increases, the number of allowable program/erase cycles decreases.

Accordingly, the write control unit 23 determines a program mode in which the number of bits to be written per memory cell is small to the block for data having high update frequency.

That is, the write control unit 23 receives a notification (e.g., in the form of a system data tag) indicating whether or not write data is data having the system data characteristics from the host 2, writes the write data into a block for data having high update frequency in the first program mode (for example, SLC mode) if the write data is data having the system data characteristics, and writes the write data into a block for data having low update frequency in the second program mode (for example, TLC mode) if the write data is not the data having the system data characteristics.

With this, although the total amount of data that can be written into each block for data having high update frequency is smaller than the total amount of data that can be written into each block for data having low update frequency, it is possible to increase the number of allowable program/erase cycles of each block for data having high update frequency and to improve reliability of data written into such blocks.

The GC control unit 24 selects one or more blocks having a small amount of valid data as GC source blocks to be subjected to the GC, from a block group used as blocks for data having high update frequency and holding valid data, and a block group used as blocks for data having low update frequency and holding valid data. Then, the GC control unit 24 copies valid data in the one or more blocks selected as the GC source blocks to one or more GC destination blocks.

The NAND interface 13 is a NAND control circuit configured to control the NAND flash memory 5. Toggle or an Open NAND Flash Interface (ONFI) may be used as an interface for interconnecting the NAND interface 13 and the NAND flash memory 5. The NAND interface 13 may be connected to each of a plurality of NAND flash memory chips in the NAND flash memory 5 via each of a plurality of channels.

The DRAM interface 14 is a DRAM control circuit configured to control the DRAM 6. A portion of a storage area of the DRAM 6 functions as a write buffer (WB) 31. Another portion of the storage area of the DRAM 6 is used for storing the address translation table 32, system management information 33, and the like. The system management information 33 may include, for example, information indicating an amount of valid data in each block in the NAND flash memory 5. In the case where the flash storage device 3 is configured not to include the DRAM 6, a portion of the storage area in the SRAM of the controller 4 may function as the write buffer (WB) 31 and another portion of the storage area in the SRAM may be used for storing the address translation table 32, the system management information 33, and the like.

Next, a configuration of the host 2 will be described. The host 2 includes a processor (e.g., CPU) that executes host software. The host software may include an application software layer 41, an operating system (OS) 42, and a file system 43.

Generally, the operating system (OS) 42 is software configured to manage the entire host 2, to control hardware in the host 2, and to execute control to enable application software to use hardware and the flash storage device 3.

The file system 43 is used to perform control for file operation (e.g., creation, saving, update, deletion, and the like). The file system 43 includes a system data management unit 43A.

The system data management unit 43A sets the system data tag to a specific value so as to notify the flash storage device 3 that write data has the system data characteristics.

A variety of application software can run on the application software layer 41. When the application software layer 41 needs to send a request such as reading or writing of data to the flash storage device 3, the application software layer 41 sends the request to the OS 42. The OS 42 sends the request to the file system 43. The file system 43 translates the request to a command (read command, write command, and the like). The file system 43 sends the command to the flash storage device 3.

If write data to be written into the flash storage device 3 is system data, the system data management unit 43A of the file system 43 sends a system data tag of a specific value indicating that the write data is data having the system data characteristics to the flash storage device 3.

The system data tag transmitted to the flash storage device 3 may be included in a write command sent from the host 2 to the flash storage device 3 or may be included in a specific command sent from the host 2 to the flash storage device 3 before the write command.

When a response from the flash storage device 3 is received, the file system 43 sends the response to the OS 42. The OS 42 sends the response to the application software layer 41.

Update frequency of write data received from the host 2 is different for each data. The controller 4 may also determine update frequency of individual write data using its own determination criterion only.

However, if the controller 4 determines the update frequency of the write data using its own determination criterion only, a mismatch between actual update frequency of the write data and the determination result of the controller 4 may occur. In this case, for example, data having high update frequency might be determined to be data having low update frequency by the controller 4, and might be written into a block for data having low update frequency.

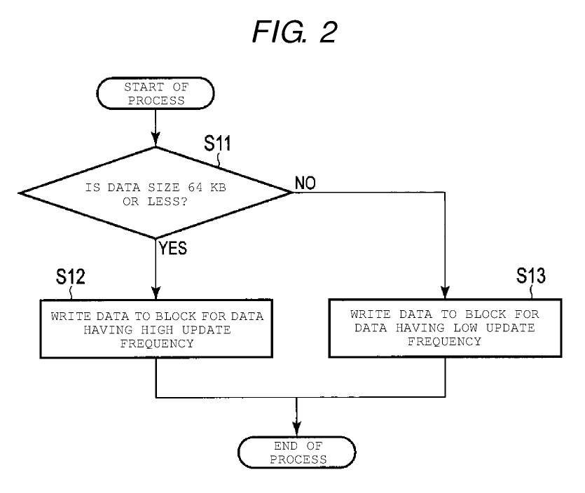

Hereinafter, with reference to FIGS. 2 to 7, an example of a process in a case where the controller 4 determines update frequency of individual data using its own determination criterion only will be described.

In the following, a case of determining whether or not write data is data having high update frequency, based on whether or not the size of the write data received from the host 2 is equal to or less than a threshold value is given as an example.

A flowchart of FIG. 2 illustrates a procedure of determining a write destination block into which write data received from the host 2 is to be written, based on the data size designated by a write command received from the host 2. Hereinafter, a case where the threshold value is 64 kilobytes (64 KB) will be described by way of an example.

The controller 4 determines whether or not the size of the write data received from the host 2 is 64 KB or less, based on the data size designated by the write command (Step S11).

When it is determined that the size of the write data is 64 KB or less (YES in Step S11), the controller 4 determines that the write data is data having high update frequency and writes the write data to a block for data having high update frequency (Step S12).

On the other hand, when it is determined that the size of the write data exceeds 64 KB (NO in Step S11), the controller 4 determines that the write data is data having low update frequency and writes the write data to another block for data having low update frequency (Step S13).

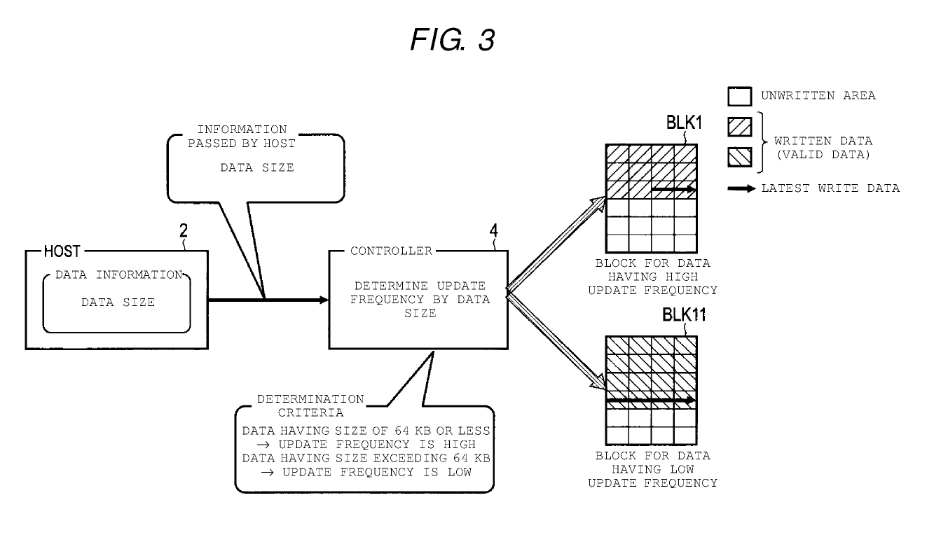

FIG. 3 illustrates an example of an operation of selectively writing write data to a block for data having high update frequency or to a block for data having low update frequency, based on the size of the write data. One cell in each of the write destination blocks BLK1 and BLK11 represents a storage area of 32 kilobytes (32 KB).

The host 2 sends a write command that includes information indicating the size of write data to be written to the controller 4. The controller 4 determines update frequency of the write data based on the size of the write data designated by the write command received from the host 2. For example, the controller 4 determines that the write data having a size of 64 KB or less is data having high update frequency and determines that the write data having a size exceeding 64 KB is data having low update frequency.

Then, the controller 4 writes the write data determined to be data having high update frequency in the block for data having high update frequency (here, write destination block BLK1), and writes the write data determined to be data having low update frequency in the block for data having low update frequency (here, write destination block BLK11).

In the NAND flash memory 5, new data cannot be overwritten directly in an area in a block where data is already written. For that reason, as described above, in a case of updating data already written, the controller 4 executes an operation of writing the new data in an unwritten area in the block or another block and managing the previous data as invalid data.

Accordingly, in a block for data having high update frequency or a block for data having low update frequency, the amount of invalid data increases due to data updates therein.

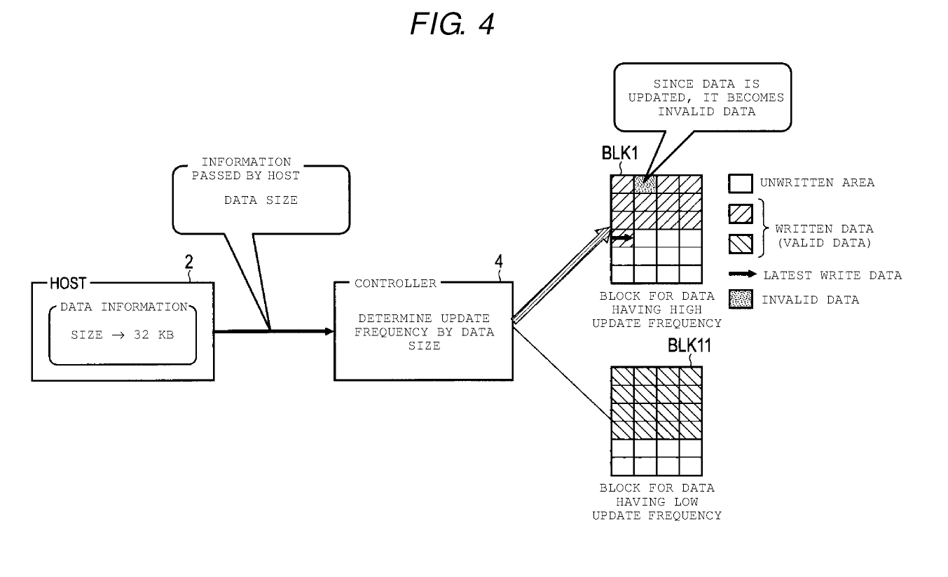

FIG. 4 illustrates an example in which fragmentation occurs in the block for data having high update frequency. As described above, one cell in each of the write destination blocks BLK1 and BLK11 represents a storage area of 32 KB.

In FIG. 4, a case where the controller 4 receives a write command requesting writing of write data having a data size of 32 KB from the host 2 is assumed. The controller 4 determines that the write data having the data size of 32 KB is data having high update frequency. Then, the controller 4 writes the write data having the data size of 32 KB to the block for data having high update frequency (here, the write destination block BLK1). In a case where the write data is updated data of already written data, the previous data, that is, 32-KB data having the same logical address as the logical address of the write data is invalid data. Data having high update frequency is updated frequently. Accordingly, in the write destination block BLK1, the amount of invalid data increases due to data update, and fragmentation likely occurs.

On the other hand, with respect to the block for data having low update frequency (here, the write destination block BLK11), as long as only data having low update frequency is written to the write destination block BLK11, the amount of data to be invalidated is smaller than that of the block BLK1 and thus, fragmentation rarely occurs as compared with the block BLK1.

However, in some cases, data having high update frequency with the data size being large might be received from the host 2, and such data might be written into the block for data having low update frequency.

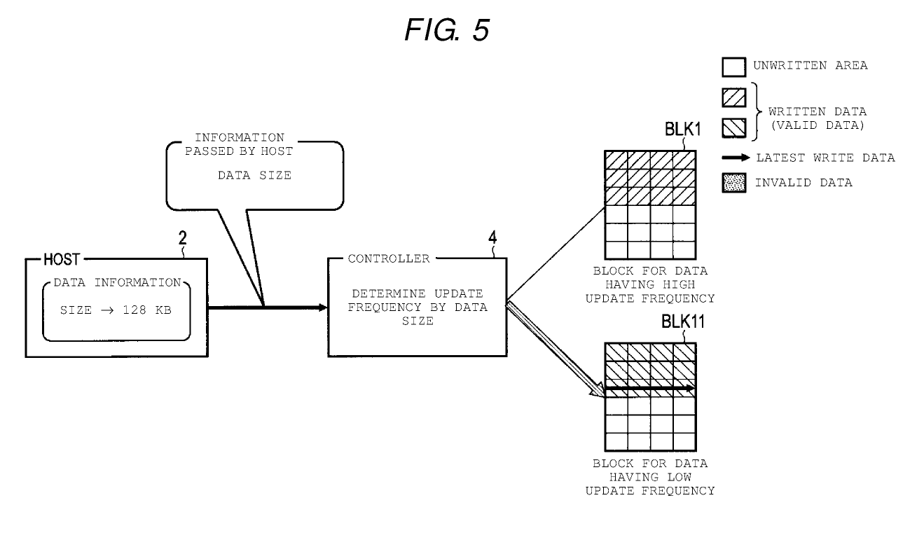

FIG. 5 illustrates an example in which data having high update frequency is written into the block for data having low update frequency.

In FIG. 5, a case that write data having a size of 128 KB and high update frequency is received from the host 2 is assumed.

In this case, the controller 4 determines that the write data is data having low update frequency, and writes the write data in the block for data having low update frequency (here, write destination block BLK11).

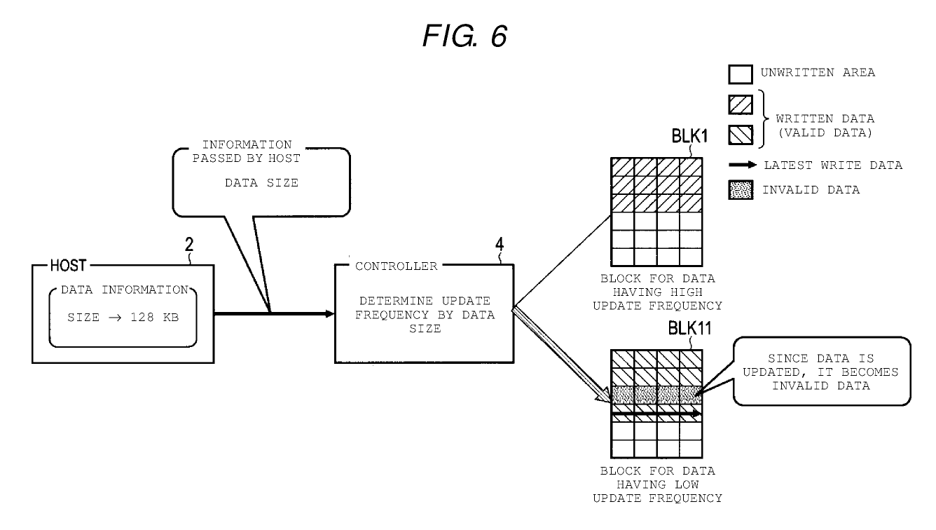

FIG. 6 illustrates an example in which updated data of data having a data size of 128 KB written in FIG. 5 is written in the block for data having low update frequency (here, write destination block BLK11), thereby causing fragmentation.

In FIG. 6, a case where the controller receives a write command requesting writing of write data having a data size of 128 KB from the host 2 is assumed. The controller 4 determines that the write data having the data size of 128 KB is data having low update frequency. Then, the controller 4 writes the write data having the data size of 128 KB to the block for data having low update frequency (here, the write destination block BLK11). Since the write data is updated data of data having the data size of 128 KB written in FIG. 5, that is, since the write data has the same logical address as the data written in FIG. 5, the write data is written into the write destination block BLK11 such that the data written in FIG. 5 and having the data size of 128 KB becomes invalid data.

As such, if data having high update frequency is written into the block for data having low update frequency, previous data that has already been written in the block for data having low update frequency becomes invalid data, and fragmentation occurs in the block for data having low update frequency. For that reason, if data having high update frequency is written to the block for data having low update frequency, the amount of data that can be written into the block for data having low update frequency decreases. In addition, the frequency at which operation (for example, GC operation) of copying valid data in a block to a new block is also increased, which causes a decrease in performance of the flash storage device 3 and an increase in a write amplification factor. The write amplification factor (WAF) is defined as follows.

WAF=“Total amount of data written to flash storage device”/“Total amount of data written from host to flash storage device”; where the “Total amount of data written to flash storage device” corresponds to the sum of the total amount of data written from the host to the flash storage device and the total amount of data internally written to the flash storage device by the GC or the like.

An increase in the WAF causes an increase in the number of times of each block in the NAND flash memory 5 is rewritten (also referred to as the number of program/erase cycles), which might cause a decrease in a lifetime of the flash storage device 3.

In general, the size of system data is relatively small. However, large-sized system data such as a log having a large size including various information or metadata having a large size including various information might be used. Most of the system data are frequently updated.

Accordingly, the system data having a large size is one type of data having a large data size and high update frequency.

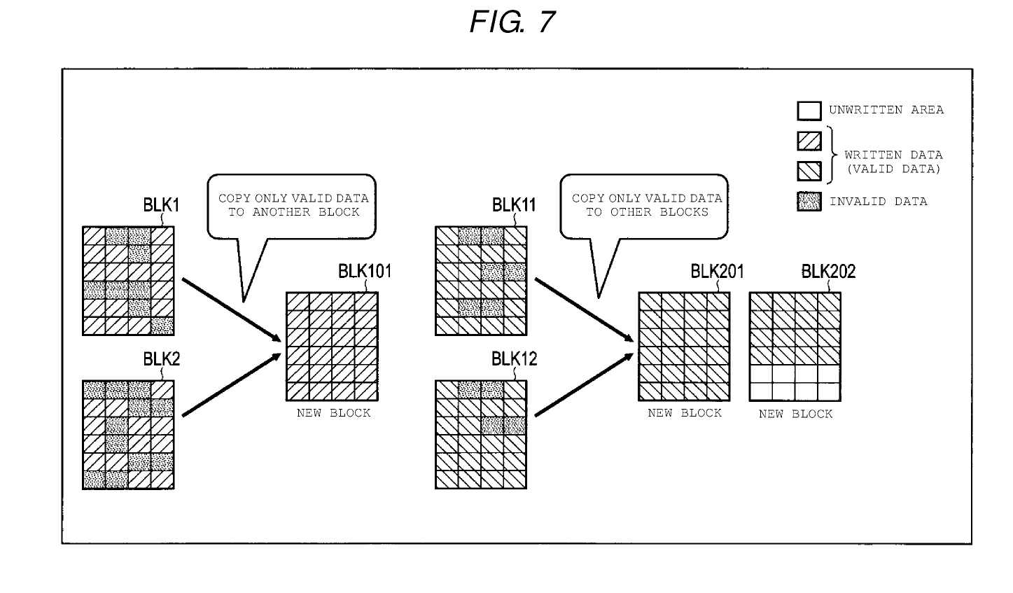

FIG. 7 illustrates an example of the GC operation performed on both a block for data having high update frequency and a block for data having low update frequency.

The left portion of FIG. 7 illustrates the GC operation applied to several blocks for data having high update frequency.

Here, a case where the blocks BLK1 and BLK2 which are used as blocks for data having high update frequency are selected as blocks to be subjected to the GC operation (i.e., GC source blocks) and pieces of valid data in the blocks BLK1 and BLK2 are copied to a new block (here, block BLK101) selected as a GC destination block is given as an example.

The right portion of FIG. 7 illustrates the GC operation performed on several blocks for data having low update frequency.

If data having high update frequency is written to each of the blocks for data having low update frequency, the amount of valid data in such blocks tends to decrease and fragmentation tends to occur. Thus, such blocks might likely be selected as the GC source blocks to be subjected to the GC operation.

In the right portion of FIG. 7, the block BLK11 for data having low update frequency and the block BLK12 for data having low update frequency are selected as GC source blocks, and the pieces of valid data in the blocks BLK11 and BLK12 are copied to new blocks (here, block BLK201 and block BLK202) selected as GC destination blocks is given as an example.

As will be understood from the explanation of FIGS. 2 to 7, if the controller 4 determines update frequency of the write data using its own determination criterion only, data having high update frequency might be written to a block for data having low update frequency, despite the large data size. As a result, fragmentation occurs in the block for data having low update frequency, and the amount of data that can be written in the block for data having low update frequency decreases.

Data having high update frequency is data that should not be ordinarily written in a block for data having low update frequency. Accordingly, if the data having high update frequency is written in the block for data having low update frequency, the amount of data written to the block for data having low update frequency is increased as compared with the case where the data is written in the block for data having high update frequency. With this, a current write destination block for data having low update frequency is consumed more quickly.

A decrease in the amount of data that can be written to the block for data having low update frequency or an increase in the amount of data written to the block for data having low update frequency increases the frequency at which the GC or wear leveling is executed, which might degrade performance of the flash storage device 3.

In the first embodiment, the controller 4 determines write data, which is designated as data having the system data characteristics by the system data tag from the host 2, to be data having high update frequency irrespective of the data size. Accordingly, even in a case where writing of write data having a large data size and high update frequency (for example, system data having a large size) is requested by the host 2, the controller 4 can write the write data into a block for data having high update frequency. For that reason, it is possible to prevent data, which should not be ordinarily written in a block for data having low update frequency (for example, system data having a large size), from being written in a block for data having low update frequency. Thus, it is possible to prevent a decrease in the amount of data that can be written to the block for data having low update frequency and an increase in the amount of data written to the block for data having low update frequency, so that the utilization efficiency of a storage capacity can be improved and performance degradation of the flash storage device 3 can be prevented.

Next, a configuration for supporting a system data tag will be described.

The flash storage device 3 of the first embodiment may be implemented as a storage device conforming to the universal flash storage (UFS) standard. In this case, the system data tag described above is represented by a group number field included in a write command specified by the UFS standard. The group number field may be referred to as “group number” or “group number area”. The controller 4 checks a value of the group number field to determine whether or not write data from the host 2 is data having the system data characteristics, that is, whether or not the write data is data having high update frequency.

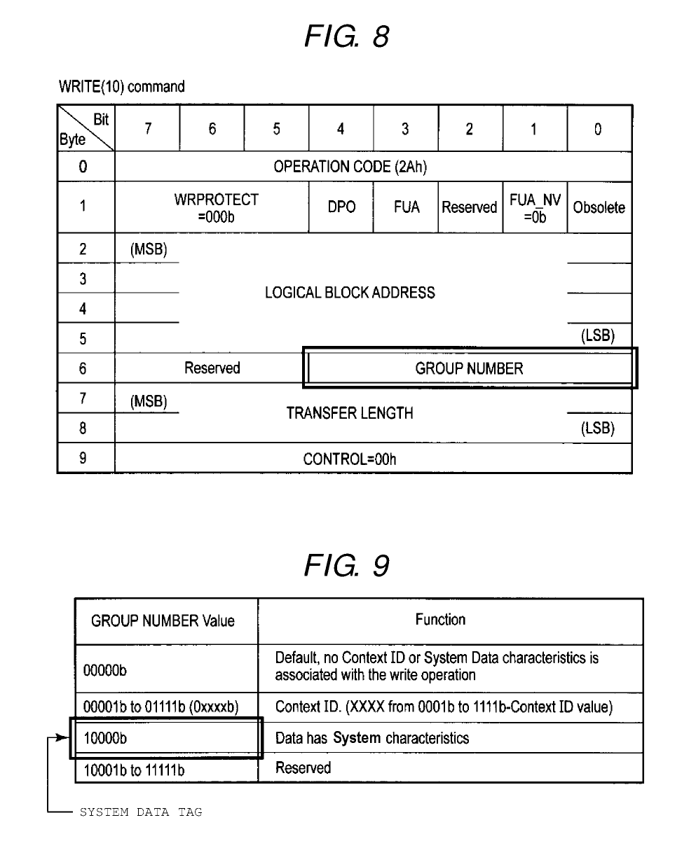

FIG. 8 illustrates a write command (WRITE (10) command is exemplified) specified by the UFS 2.1 standard to which the flash storage device 3 of the first embodiment may conform.

The flash storage device 3 can function as a storage device conforming to the UFS 2.1 standard and can process various commands specified by the UFS 2.1 standard.

The WRITE (10) command illustrated in FIG. 8 is a command that requests the flash storage device 3 to perform data writing. The WRITE (10) command includes a GROUP NUMBER field, in addition to fields for OPERATION CODE, LOGICAL BLOCK ADDRESS, and TRANSFER LENGTH.

The GROUP NUMBER field is used to notify a target device that the write data to be written has system data characteristics or is associated with a context ID.

The LOGICAL BLOCK ADDRESS indicates the first logical address to which the write data is to be written and the TRANSFER LENGTH indicates the size (length) of the write data.

FIG. 9 illustrates a system data tag which is set in the GROUP NUMBER field included in the write command of FIG. 8.

The size of the GROUP NUMBER field is 5 bits. The value 00000b of the GROUP NUMBER field is a default value, which indicates that the context ID or the system data characteristics is not associated with the write data. The value 10000b of the GROUP NUMBER field is used as the system data tag indicating that the write data has the system data characteristics. Values 10001b to 11111b of the GROUP NUMBER field are reserved values (i.e., undefined values).

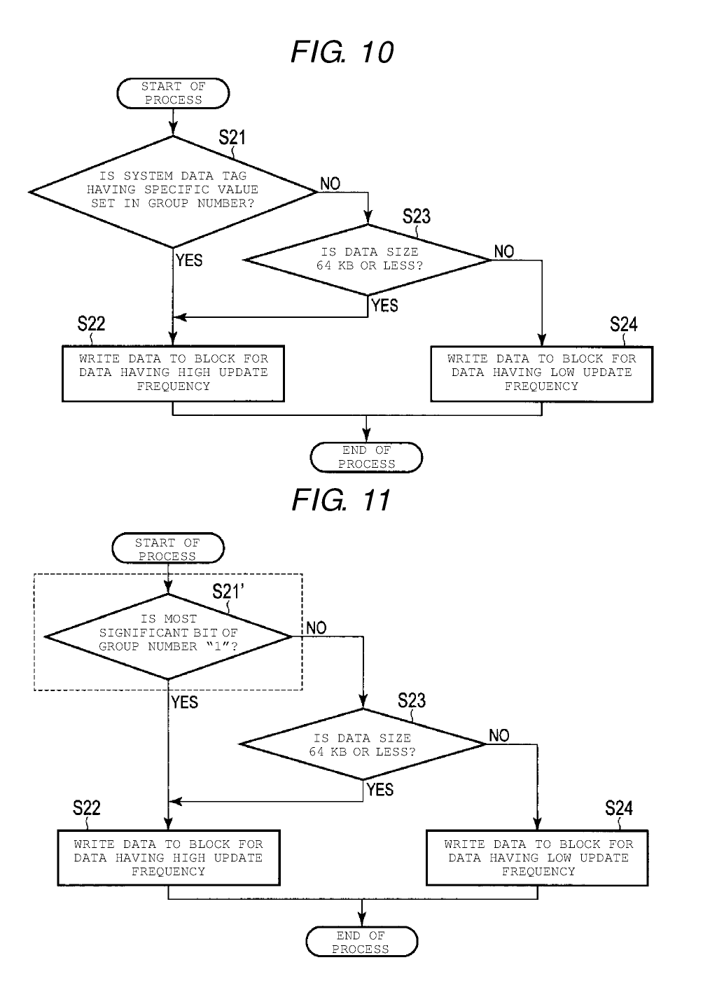

A flowchart of FIG. 10 illustrates a procedure of a write process executed by the flash storage device 3, based on whether or not a system data tag having a specific value is set in the GROUP NUMBER field.

The system data tag having the specific value indicates that the write data is data having the system data characteristics.

In a case where the controller 4 of the flash storage device 3 receives a write command from the host 2, the controller 4 checks the value of the system data tag included in the write command. In the UFS standard, the system data tag is represented by the GROUP NUMBER field included in a write command specified by the UFS standard. Accordingly, the controller 4 refers to the GROUP NUMBER field in the received write command and determines whether or not the system data tag having a specific value (for example, 10000b) is set in the GROUP NUMBER field (Step S21).

If the system data tag having a specific value (for example, 10000b) is set in the GROUP NUMBER field, that is, if the write data is designated as data having the system data characteristics by the system data tag (YES in Step S21), the controller 4 determines that the write data corresponding to the write command is data having high update frequency. Then, the controller 4 writes the write data to a block for data having high update frequency (Step S22). In Step S22, the controller 4 may write the write data into the block for data having high update frequency in the SLC mode.

If the system data tag having a specific value (for example, 10000b) is not set in the GROUP NUMBER field, that is, if the write data is not designated as data having the system data characteristics by the system data tag (NO in Step S21), the controller 4 determines whether or not the size of the write data is equal to or less than a threshold value (here, 64 KB), based on the data size designated by the write command (Step S23).

If the size of the write data is 64 KB or less (YES in Step S23), the controller 4 determines that the write data is data having high update frequency and writes the write data into a block for data having high update frequency (Step S22). As described above, in Step S22, the controller 4 may write the write data in the block for data having high update frequency in the SLC mode.

On the other hand, if the size of the write data exceeds 64 KB (NO in Step S23), the controller 4 determines that the write data is data having low update frequency, and writes the write data into a block for data having low update frequency (Step S24). In Step S24, the controller 4 may write the write data in the block for data having low update frequency in the TLC mode.

As such, the controller 4 treats the write data, which is designated as data having the system data characteristics by the system data tag from the host 2, as data having high update frequency and writes the write data into a block for data having high update frequency so as to make it possible to prevent a decrease in the amount of data that can be written to the block for data having low update frequency and an increase in the amount of data written to the block for data having low update frequency.

In the flowchart of FIG. 10, when the write data is not designated as data having the system data characteristics by the system data tag, a process of distributing the write data to the block for data having high update frequency or to the block for data having low update frequency is executed based on the data size designated by the write command. However, the process of distributing the write data based on the data size does not have to be executed. In this case, the controller 4 may write the write data not designated as data having the system data characteristics by the system data tag into the block for data having low update frequency.

A flowchart of FIG. 11 illustrates a procedure of a write process executed by the flash storage device 3 based on a value of the most significant bit of the GROUP NUMBER field.

As described above, since the default value of the GROUP NUMBER field is 00000b, the value 10000b of the GROUP NUMBER field indicates the system data tag, and the reserved values 10001b to 11111b of the GROUP NUMBER field are basically not used, the controller 4 may determine whether or not write data to be written has the system data characteristics by checking only the most significant bit of the GROUP NUMBER field.

That is, in a case where the controller 4 receives a write command from the host 2, the controller 4 checks the value of the system data tag included in the write command. In this case, the controller 4 determines whether or not the most significant bit of the GROUP NUMBER field in the received write command is “1” (Step S21′).

When it is determined that the most significant bit is “1”, that is, if it can be regarded that the write data is designated as data having the system data characteristics by the system data tag (YES in Step S21′), the controller 4 determines that the write data corresponding to the write command is data having high update frequency and executes the process of step S22 described with reference to FIG. 10.

When it is determined that the most significant bit is not “1”, that is, if it cannot be regarded that the write data is designated as data having the system data characteristics by the system data tag (NO in Step S21′), the controller 4 executes the process in step S23 described in FIG. 10 and executes the process in step S22 or step S24 described in FIG. 10 according to the size of the write data.

In the flowchart of FIG. 11, when it cannot be regarded that the write data is designated as data having the system data characteristics, a process of distributing the write data to the block for data having high update frequency or to the block for data having low update frequency is executed based on the data size designated by the write command. However, the process of distributing the write data based on the data size does not necessarily have to be executed. In this case, the controller 4 may write the write data not designated as data having the system data characteristics by the system data tag into the block for data having low update frequency.

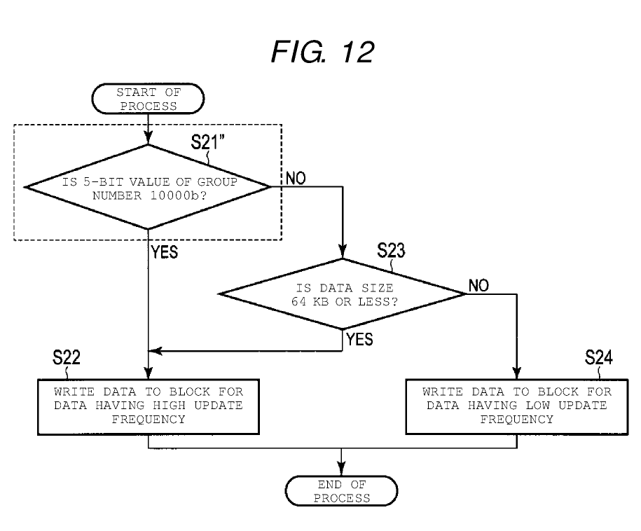

A flowchart of FIG. 12 illustrates a procedure of a write process executed by the flash storage device 3 based on a 5-bit value of the GROUP NUMBER field.

In a case where the controller 4 receives a write command from the host 2, the controller 4 checks a value of the system data tag included in the write command. In this case, the controller 4 determines whether or not the 5-bit value of the GROUP NUMBER field in the received write command is 10000b (Step S21″).

If the 5-bit value of the GROUP NUMBER field is 10000b, that is, if it can be regarded that the write data is designated as data having the system data characteristics by the system data tag (YES in Step S21″), the controller 4 determines that the write data corresponding to the write command is data having high update frequency and executes the process in Step S22 described in FIG. 10.

If the 5-bit value of the GROUP NUMBER field is not 10000b, that is, if it cannot be regarded that the write data is designated as data having the system data characteristics by the system data tag (NO in Step S21″), the controller 4 executes the process in Step S23 described in FIG. 10 and executes the process in Step S22 or Step S24 described in FIG. 10 according to the size of the write data.

In the flowchart of FIG. 12, when it cannot be regarded that the write data is designated as data having the system data characteristics, a process of distributing the write data to the block for data having high update frequency or to the block for data having low update frequency is executed based on the data size designated by the write command. However, the process of distributing the write data based on the data size does not have to be executed. In this case, the controller 4 may write the write data not designated as data having the system data characteristics by the system data tag into the block for data having low update frequency.

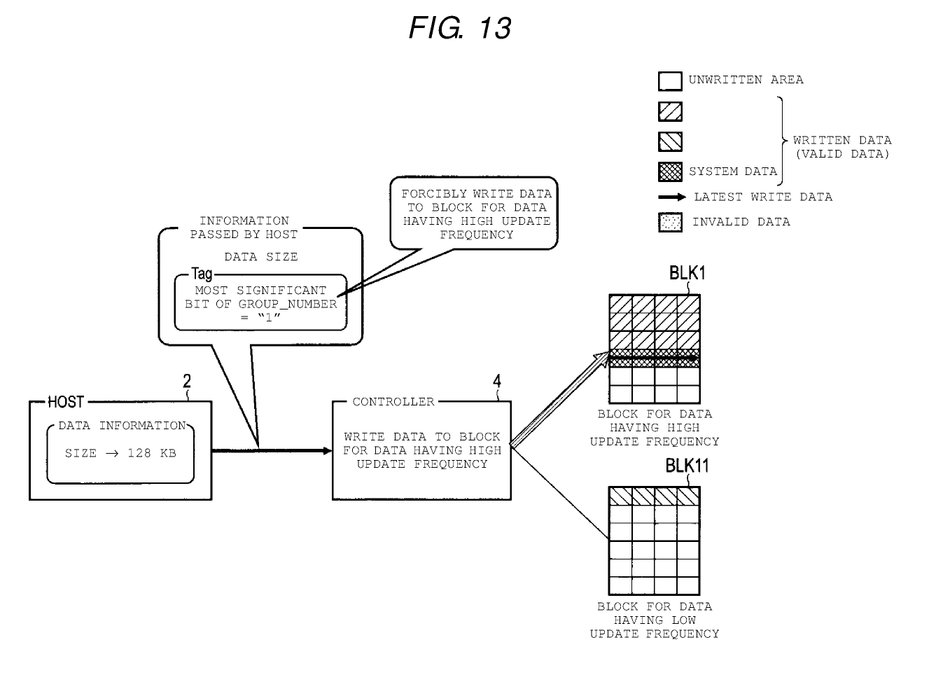

FIG. 13 illustrates an operation of writing data having a high update frequency and a large data size into a block for data having high update frequency.

Here, a case where data update frequency is determined based on the most significant bit of the GROUP NUMBER field will be given as an example.

In a case where the host 2 is going to write system data having the size of 128 KB to the flash storage device 3, the host 2 sets the most significant bit of the GROUP NUMBER field to “1” in order to notify the flash storage device 3 that the data has the system data characteristics. In a case where the most significant bit of the GROUP NUMBER field is “1”, the controller 4 determines that the write data from the host 2 is data having high update frequency. Then, the controller 4 writes the write data to a block for data having high update frequency (here, the write destination block BLK1).

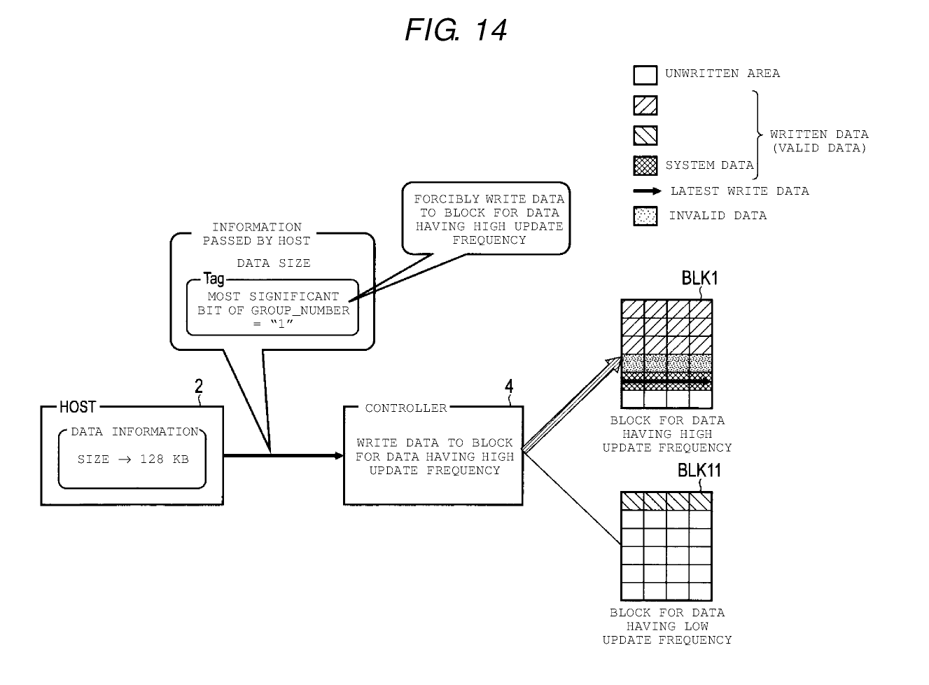

FIG. 14 illustrates an operation of updating the data written in FIG. 13.

When the host 2 is going to write updated data (for example, system data having a size of 128 KB) of the data written in FIG. 13 to the flash storage device 3, the host 2 sets the most significant bit of the GROUP NUMBER field to “1”. In a case where the most significant bit of the GROUP NUMBER field is “1”, the controller 4 determines that the write data from the host 2 is data having high update frequency. Then, the controller 4 writes the write data to the block for data having high update frequency (here, the write destination block BLK1).

Since the write data is updated data of the data written in FIG. 13, the data written in FIG. 13 becomes invalid data.

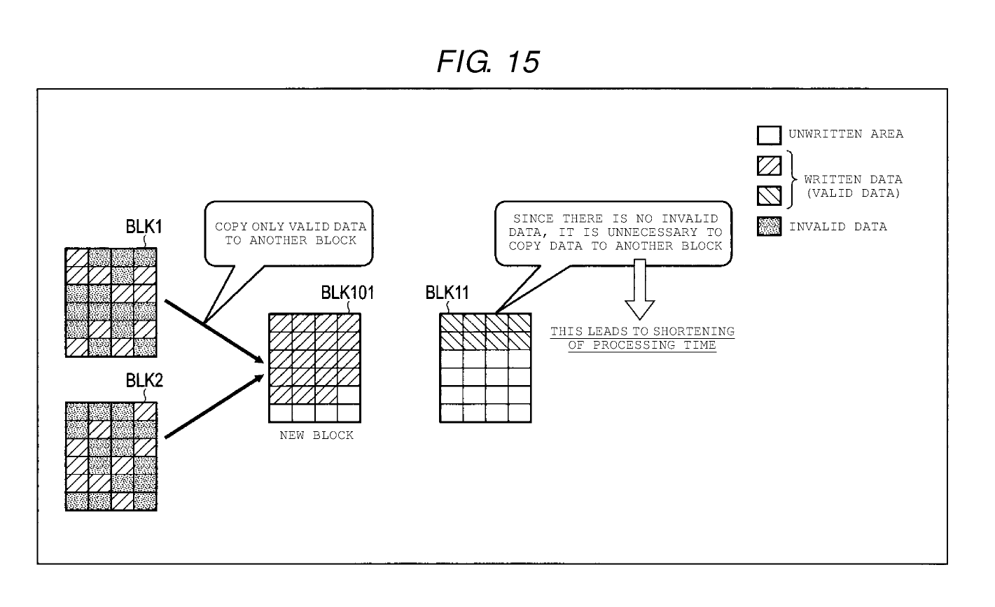

FIG. 15 illustrates a GC operation corresponding to a case where fragmentation occurs in a block group for data having high update frequency and fragmentation does not occur in a block for data having low update frequency.

In the first embodiment, regardless of the size of the write data, the write data designated as data having the system data characteristics by the host 2 is written to a block for data having high update frequency. Accordingly, even in a case where the write data has a large size, if the write data has the system data characteristics, the write data is written into the block for data having high update frequency. Therefore, in a block for data having low update frequency (here, the block BLK11), fragmentation due to invalidating data in updating the data hardly occurs. Thus, although the block group for data having high update frequency (in this case, blocks BLK1 and BLK2) is a target for the GC, the block for data having low update frequency (here, the block BLK11) hardly becomes a target for the GC.

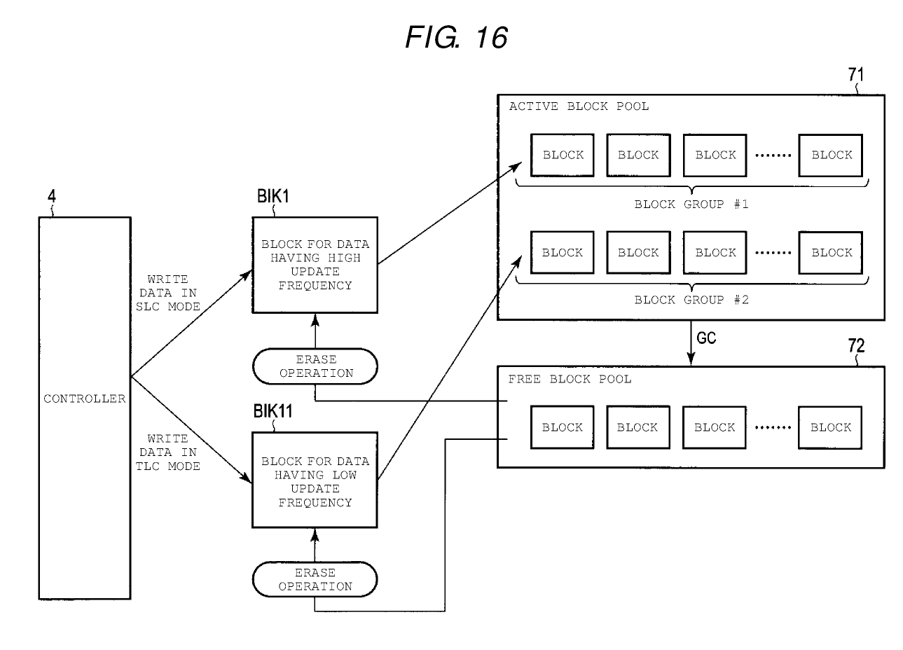

FIG. 16 illustrates a relationship between an active block pool, a free block pool, and two write destination blocks.

A state of the block is roughly divided into an active block storing valid data and a free block not storing valid data. Each active block is managed by a list called an active block pool 71. On the other hand, each free block is managed by a list called a free block pool 72.

The controller 4 allocates one free block selected from the free block pool 72 as a write destination block BLK1 for data having high update frequency and allocates another free block selected from the free block pool 72 as a write destination block BLK11 for data having low update frequency. In this case, the controller 4 first executes an erase operation for each selected free block and manages each of the selected free blocks as an erased state into which data can be written.

The controller 4 writes data into the write destination block BLK1 for data having high update frequency, for example, in the SLC mode, and writes data into the write destination block BLK11 for data having low update frequency, for example in the TLC mode.

When the entire current write destination block BLK1 for data having high update frequency is filled with write data from the host 2 and there is no unwritten area in the write destination block BLK1, the controller 4 manages the write destination block BLK1 as a block in the active block pool 71. Then, the controller 4 selects a new free block from the free block pool 72 and allocates the selected free block as a new write destination block for data having high update frequency.

Similarly, when the entire current write destination block BLK11 for data having low update frequency is filled with write data from the host 2 and there is no unwritten area in the write destination block BLK11, the controller 4 manages the current write destination block BLK 11 for data having low update frequency as a block in the active block pool 71. Then, the controller 4 selects a new free block from the free block pool 72 and allocates the selected free block as a new write destination block for data having low update frequency.

At least a portion of the storage areas in each block in the active block pool 71 holds valid data. In the active block pool 71, a first block group (block group #1) and a second block group (block group #2) exist. The first block group is a set of blocks having been used as a write destination block for data having high update frequency and the second block group is a set of blocks having been used as a write destination block for data having low update frequency. When all valid data in a certain block in the active block pool 71 is invalidated by data update, the unmap/trim/erase command, the GC, or the like, the controller 4 manages the block as a block in the free block pool 72.

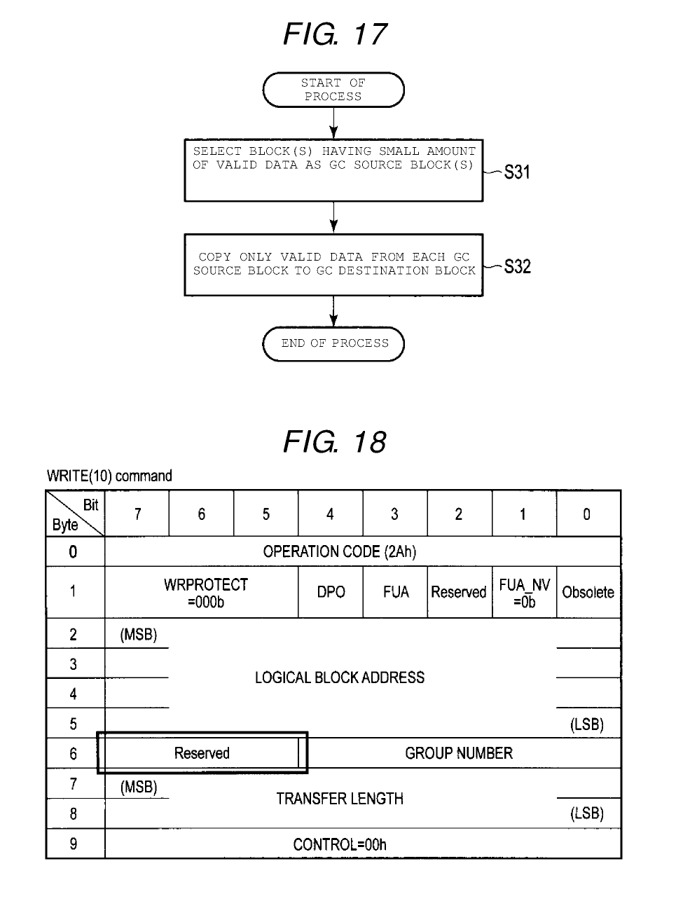

A flowchart of FIG. 17 illustrates a procedure of the GC operation.

For example, in a case where the number of available free blocks in the free block pool 72 is equal to or less than a threshold value, the controller 4 executes the GC operation.

In the GC operation, the controller 4 selects several GC source blocks to be subjected to the GC from the blocks in the active block pool 71. In this case, the controller 4 selects one or more blocks having a small amount of valid data from the blocks in the active block pool 71 as the GC source block (s) (Step S31). In Step S31, the controller 4 may select one or more blocks having the smallest amount of valid data in the active block pool 71 as the GC source block (s). Although the first block group and the second block group are included in the active block pool 71, the controller 4 may search for one or more blocks having the smallest amount of valid data without distinguishing between the first block group and the second block group.

As described above, in the first embodiment, data writing to each block for data having high update frequency may be executed in a program mode in which m bit (s) of data is written per memory cell, and data writing to each block for data having low update frequency may be executed in a program mode in which n bit (s) (n>m) of data is written per memory cell.

Accordingly, a total amount of data that can be written to each block for data having high update frequency is smaller than a total amount of data that can be written to each block for data having low update frequency. As a result, basically, the amount of valid data of each block for data having high update frequency is also smaller than that of each block for data having low update frequency. Thus, since a block for data having high update frequency will be preferentially selected as the GC source block, a block for data having low update frequency unlikely becomes a target for the GC.

Then, the controller 4 copies only valid data in the selected GC source block to a GC destination block, which is a copy destination block (Step S32). The GC source block having only invalid data as a result of the GC operation is managed as a block in the free block pool 72.

As described above, according to the first embodiment, write data designated as data having the system data characteristics by the system data tag from the host 2 is written into a block for data having high update frequency. Write data not designated as data having the system data characteristics by the system data tag from the host 2 is written to a block for data having low update frequency. As such, it is possible to write data having high update frequency and data having low update frequency into different blocks, respectively, by recognizing data having the system data characteristics designated by the system data tag from the host 2 as data having high update frequency. As a result, data having high update frequency (for example, data having a large size and high update frequency), which should not be ordinarily written in the block for data having low update frequency, can be prevented from being written into the block for data having low update frequency. Thus, it is possible to prevent a decrease in the amount of data that can be written to the block for data having low update frequency and an increase in the amount of data written to the block for data having low update frequency, so that utilization efficiency of the storage capacity can be improved and performance degradation of the flash storage device 3 can be prevented.

The value of the GROUP NUMBER field in a write command of the UFS standard may be used as the system tag and thus, utilization efficiency of the storage capacity in the system conforming to the UFS standard can be improved.

In the first embodiment, write data designated as data having the system data characteristics by the system data tag from the host 2 may be written into the NAND flash memory 5 in the first program mode (for example, SLC mode) and write data that is not designated as data having the system data characteristics may be written into the NAND flash memory 5 in the second program mode (for example, TLC mode). This can be achieved, for example, by applying the first program mode to the write destination block for the system data and applying the second program mode to the write destination block for other data. With such a configuration, the number of allowable program/erase cycles of each block in which the system data is written can be increased and thus, reliability of the system data can be enhanced.

Apart from the WRITE (10) command, a new command for notifying the system data tag, which designates that write data has the system data characteristics, may be defined and whether or not the write data is data having the system data characteristics may be notified from the host 2 to the flash storage device 3 using this command.

### Second Embodiment

In the first embodiment, a case where the GROUP NUMBER field in a write command designated by the UFS standard is used as the system data tag is described, but in a second embodiment, an undefined reserved field in the write command designated by the UFS standard is used as the system data tag.

The hardware configuration of the flash storage device 3 according to the second embodiment is the same as that of the flash storage device 3 of the first embodiment, and in the second embodiment and the first embodiment, only how the system data tag (update frequency information for notifying high update frequency/low update frequency) is specified, is different. In the following, only differences from the first embodiment will be described.

FIG. 18 illustrates an example of a reserved field of a write command being used as a system data tag.

As illustrated in FIG. 18, a write command (WRITE (10) command is exemplified) specified by the UFS 2.1 standard includes an undefined Reserved field. For example, in a case where the host 2 requests writing of system data, the host 2 sets, for example, the most significant bit of the Reserved field to “1”. The most significant bit of the Reserved field can be used as the value of the system data tag. In other words, the most significant bit of the Reserved field may be used as information for designating whether or not write data is the system data.

In a case where the most significant bit of the Reserved field in the write command is “1”, the controller 4 handles the write data as data having the system data characteristics, that is, data having high update frequency.

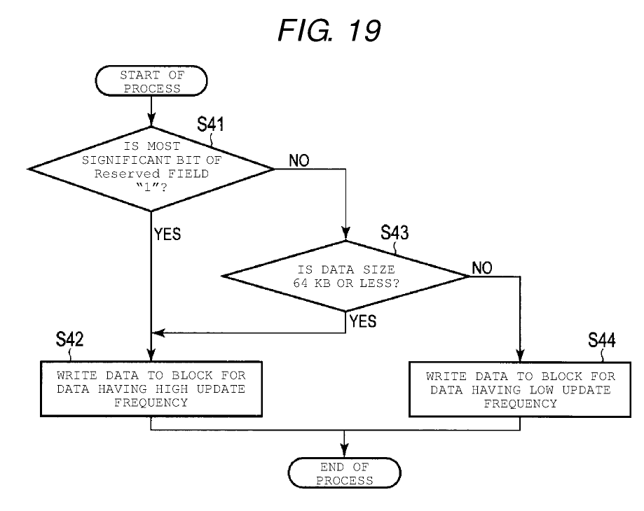

A flowchart of FIG. 19 illustrates a procedure of a write process executed based on a value of the Reserved field.

In a case where the controller 4 receives a write command from the host 2, the controller 4 checks the value of the Reserved field in the write command. In this case, the controller 4 determines whether or not the most significant bit of the Reserved field in the received write command is “1” (Step S41).

When it is determined that the most significant bit of the Reserved field is “1”, that is, when it is determined that write data is designated as data having the system data characteristics by the system data tag (YES in Step S41), the controller 4 determines that the write data corresponding to the write command is data having high update frequency. Then, the controller 4 writes the write data in a block for data having high update frequency (Step S42). In Step S42, the controller 4 may write the write data in the block for data having high update frequency in the SLC mode.

When it is determined that the most significant bit of the Reserved field is not “1”, that is, when it is determined that the write data is not designated as data having the system data characteristics by the system data tag (NO in Step S41) the controller 4 determines whether or not the size of the write data is equal to or less than a threshold value (here, 64 KB) (Step S43).

When it is determined that the size of the write data is 64 KB or less (YES in Step S43), the controller 4 determines that the write data is data having high update frequency and writes the write data to a block for data having high update frequency (Step S42). As described above, in Step S42, the controller 4 may write the write data into the block for data having high update frequency in the SLC mode.

On the other hand, when it is determined that the size of the write data exceeds 64 KB (NO in Step S43), the controller 4 determines that the write data is data having low update frequency and writes the write data into a block for data having low update frequency (Step S44). In Step S44, the controller 4 may write the write data into the block for data having low update frequency in the TLC mode.

In the flowchart of FIG. 19, when it cannot be regarded that the write data is designated as data having the system data characteristics, a process of distributing the write data to the block for data having high update frequency or to the block for data having low update frequency is executed based on the data size specified by the write command. However, the process of distributing the write data based on the data size does not have to be executed. In such a case, the controller 4 writes the write data not designated as data having the system data characteristics by the system data tag into the block for data having low update frequency.

In the second embodiment, similarly as in the first embodiment, it is possible to reduce the probability that data having high update frequency is written into a block for data having low update frequency and to improve utilization efficiency of the storage capacity.

Also in the second embodiment, the GC operation described in the first embodiment may be executed.

### Third Embodiment

In the first embodiment, a case where the GROUP NUMBER field in a write command designated by the UFS standard is used as the system data tag is described, but in a third embodiment, a tag request in the SET_BLOCK_COUNT command (CMD 23) specified in the eMMC standard is used as the system data tag.

The hardware configuration of the flash storage device 3 according to the third embodiment is basically the same as that of the flash storage device 3 of the first embodiment. The third embodiment differs from the first embodiment in that the flash storage device 3 according to the third embodiment is implemented as a storage device conforming to the eMMC standard and the tag request of the CMD 23 is used as the system data tag. In the following, only differences from the first embodiment will be described.

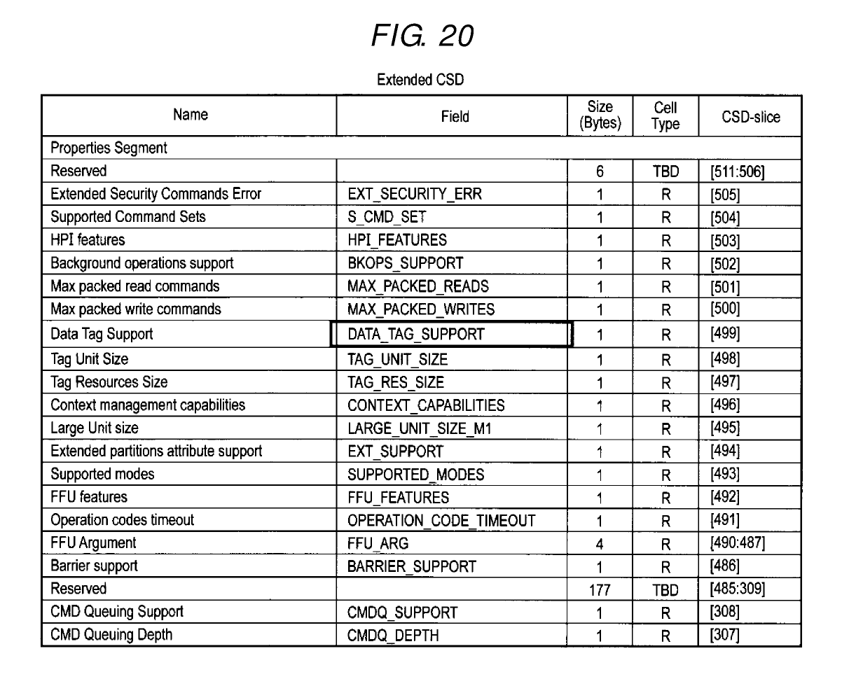

FIG. 20 illustrates a DATA_TAG_SUPPORT field in the Extended Device Specific Data (Extended CSD) Register specified by the eMMC 4.5 standard.

The flash storage device 3 of the third embodiment can function as a storage device conforming to the eMMC 4.5 standard and can process various commands specified by the eMMC 4.5 standard.

The flash storage device 3 includes the Extended CSD Register illustrated in FIG. 20. The Extended CSD Register includes a DATA_TAG_SUPPORT field for supporting a function (e.g., system data tag mechanism) for designating that write data has the system data characteristics. The host 2 can confirm that the system data tag mechanism is supported by checking a value of the DATA_TAG_SUPPORT field.

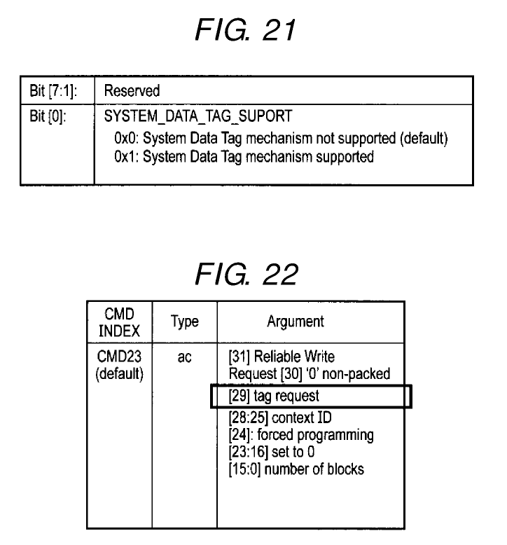

As illustrated in FIG. 21, the DATA_TAG_SUPPORT field includes 8-bit information. The least significant bit (Bit[0]) of the DATA_TAG_SUPPORT field is used as SYSTEM_DATA_TAG_SUPORT indicating whether or not the system data tag mechanism is supported. The value of one in Bit[0] of the DATA_TAG_SUPPORT field indicates that the system data tag mechanism is supported.

FIG. 22 illustrates the tag request in the SET_BLOCK_COUNT command (CMD 23) specified in the eMMC standard.

The CMD 23 is used, for example, for notifying information regarding write data to the flash storage device 3. The CMD 23 is sent to the flash storage device 3 immediately before a write command (for example, CMD 25).

The CMD 23 has a size of 32 bits, and a field of the 30-th bit (corresponding to Bit [29]) of the CMD 23 is used as the tag request. The tag request is used as the system data tag indicating whether or not the write data is data having the system data characteristics. A tag request of “1” indicates that the write data has the system data characteristics.

Based on the tag request, the controller 4 determines whether or not the write data from the host 2 has high update frequency. Regarding the write data designated as data having the system data characteristics by the tag request, the controller 4 handles the write data as data having high update frequency. That is, the controller 4 determines that the write data designated as data having the system data characteristics by the tag request (system data tag) is data having high update frequency and writes the write data into a block for writing data having high update frequency. The controller 4 determines that the write data not designated as data having the system data characteristics by the tag request is data having low update frequency and writes the write data into another block for data having low update frequency.

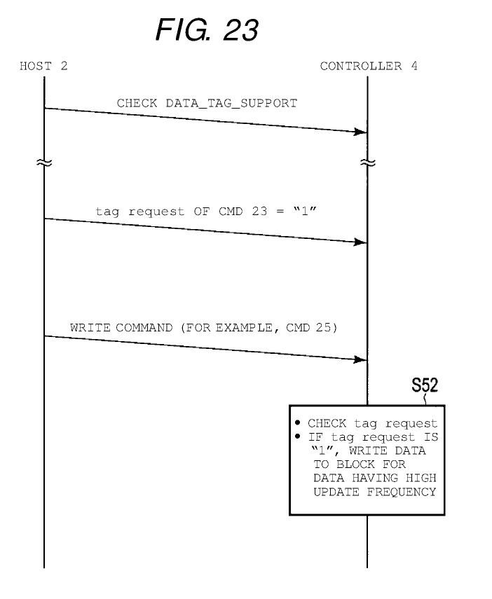

A sequence chart of FIG. 23 illustrates a procedure of a data write process executed by the host 2 and the flash storage device 3.

After the flash storage device 3 is powered on, the host checks Bit [0] (SYSTEM_DATA_TAG_SUPORT) in the DATA_TAG_SUPPORT field of the Extended CSD Register in the flash storage device 3 and confirms that the system data tag mechanism is supported.

In a case where the host 2 requests to write system data, the host 2 sends the CMD 23 with the tag request set to “1” to the flash storage device 3, and sends a write command (for example, CMD 25) to the flash storage device 3.

After the controller 4 of the flash storage device 3 receives the write command (for example, CMD 25), the controller 4 checks whether or not the tag request of the CMD 23 is set to “1”, and if the tag request of the CMD 23 is set to “1”, the controller 4 writes the write data to a block for data having high update frequency in response to the write command (Step S52). A process of determining whether or not the tag request of CMD 23 is set to “1” may be executed before reception of the write command (for example, CMD 25) or after the reception.

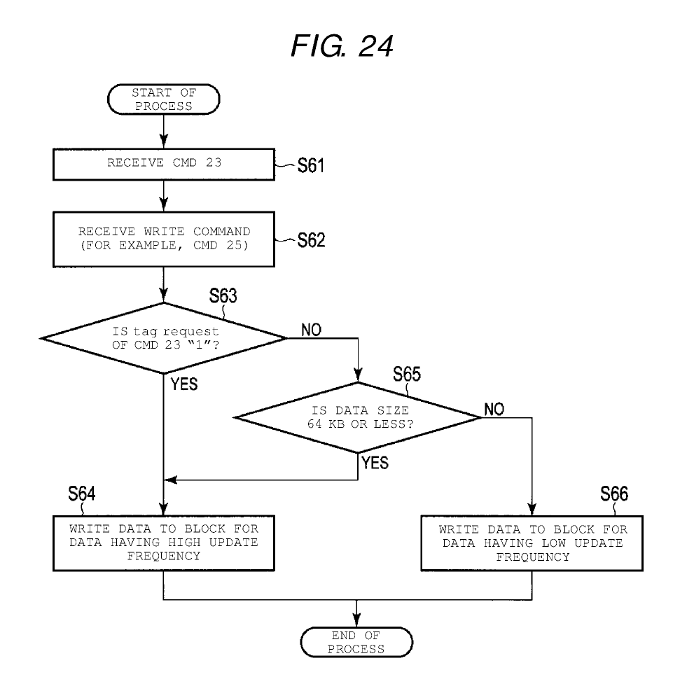

A flowchart of FIG. 24 illustrates a procedure of a write process executed based on a value of the tag request in the CMD 23.

The controller 4 receives the CMD 23 from the host 2 (Step S61), and receives a write command (for example, CMD 25) from the host 2 (Step S62). The controller 4 checks the value of the tag request included in the CMD 23 received immediately before the write command. In this case, the controller 4 determines whether or not the value of the tag request is “1” (Step S63).

When it is determined that the value of the tag request is “1”, that is, when it is determined that write data is designated as data having the system data characteristics by the tag request (YES in Step S63), the controller 4 determines that the write data is data having high update frequency. Then, the controller 4 writes the write data into a block for data having high update frequency (Step S64). In Step S64, the controller 4 may write the write data into the block for data having high update frequency in the SLC mode.

When it is determined that the value of the tag request is not “1”, that is, when it is determined that the write data is not designated as data having the system data characteristics by the tag request (NO in Step S63), the controller 4 determines whether or not the size of the write data is equal to or less than a threshold value (here, 64 KB) (Step S65).

When it is determined that the size of the write data is 64 KB or less (YES in Step S65), the controller 4 determines that the write data is data having high update frequency, and writes the write data into a block for data having high update frequency (Step S64). As described above, in Step S64, the controller 4 may write the write data in the block for data having high update frequency in the SLC mode.

On the other hand, when it is determined that the size of the write data exceeds 64 KB (NO in Step S65), the controller 4 determines that the write data is data having low update frequency, and writes the write data into a block for data having low update frequency (Step S66). In Step S66, the controller 4 may write the write data into the block for data having low update frequency in the TLC mode.

In the flowchart of FIG. 24, when it cannot be regarded that the write data is designated as data having the system data characteristics by the tag request, a process of distributing the write data to the block for data having high update frequency or to the block for data having low update frequency is executed based on the data size designated by the write command. However, the process of distributing the write data based on the data size does not have to be executed. In this case, the controller 4 may write the write data not designated as data having the system data characteristics by the tag request (system data tag) into the block for data having low update frequency.

In the third embodiment, similarly to the first embodiment, it is possible to reduce the probability that data having high update frequency is written into the block for data having low update frequency, thereby improving utilization efficiency of the storage capacity. In the third embodiment, since the value of the tag request in the SET_BLOCK_COUNT command (CMD 23) of the eMMC standard can be used as the system tag, it is possible to improve utilization efficiency of the storage capacity in the system conforming to the eMMC standard.

Also in the third embodiment, the GC operation described in the first embodiment can be executed.

### Fourth Embodiment

A case where the controller 4 determines whether or not write data is system data based on the system data tag included in a command (write command or CMD 23) from the host 2 is described in the first, second and third embodiments. The controller 4 may determine whether or not the write data is the system data based on the value of a signal line added to an interface interconnecting the host 2 and the flash storage device 3 in a fourth embodiment.

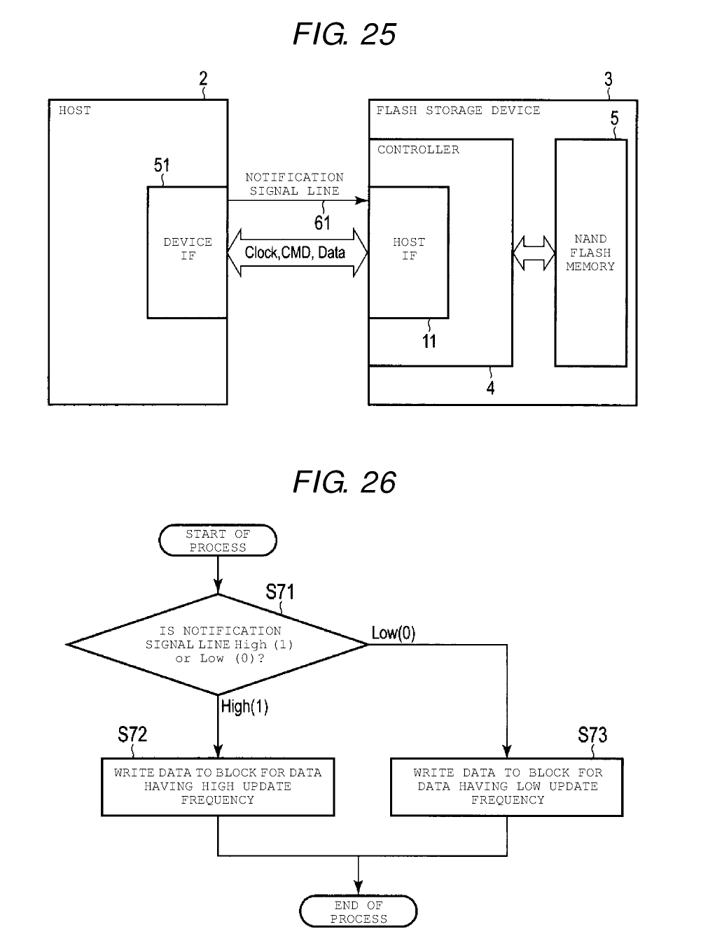

FIG. 25 illustrates the signal line defined in the interface interconnecting the flash storage device 3 and the host 2.

That is, in the interface, the notification signal line 61 is added, in addition to a plurality of signal lines for transferring clocks, commands (CMDs), and data.

A device interface 51 of the host 2 includes a circuit for setting the notification signal line 61 to a high level (logical “1”) or a low level (logical “0”) based on an instruction from host software such as the file system 43.

The controller 4 of the flash storage device 3 checks the value (logical “1” or logical “0”) of the notification signal line 61 using the host interface 11, determines, based on the value of the notification signal line 61, whether or not write data is system data, and selectively writes the write data into a block for data having high update frequency or a block for data having low update frequency, based on the determination.

For example, the host 2 sets the notification signal line 61 to a high level (logical “1”) when the system data is to be written and sets the notification signal line 61 at a low level when data other than the system data (logical “0”) is to be written so as to make it possible to notify the flash storage device 3 of whether or not the write data is the system data.

A flowchart of FIG. 26 illustrates a procedure of a write process executed based on the value of the notification signal line 61.

When the controller 4 receives a write command from the host 2, the controller 4 determines whether the notification signal line 61 is at a high level (logical “1”) or a low level (logical “0”) (Step S71).

When it is determined that the notification signal line 61 is at the high level (logical “1”), the controller 4 determines that write data is system data. Then, the controller 4 writes the write data in a block for data having high update frequency (Step S72). In Step S72, the controller 4 may write the write data in the block for data having high update frequency in the SLC mode.

When it is determined that the notification signal line is at the low level (logical “0”), the controller 4 determines that write data is not system data. Then, the controller 4 writes the write data in a block for data having low update frequency (Step S73). In Step S73, the controller 4 may write the write data in the block for data having low update frequency in the TLC mode.

In the fourth embodiment, similar to the first embodiment, it is possible to reduce the probability that data having high update frequency is written into a block for data having low update frequency and improve utilization efficiency of the storage capacity. Also in the fourth embodiment, the GC operation described in the first embodiment can be executed.

In a case where the notification signal line 61 is at the low level (logical “0”), the controller 4 may selectively write the write data into a block for data having high update frequency or a block for data having low update frequency according to the size of the write data. In this case, the controller 4 determines whether or not the size of the write data is equal to or less than a threshold value (for example, 64 KB), writes the write data into the block for data having high update frequency when the size of the write data is equal to or less than the threshold value, and writes the write data into the block for data having low update frequency when the size of the write data exceeds the threshold value.

In the fourth embodiment, the notification signal line 61 is described as a signal line for notifying the flash storage device 3 that the write data is the system data. However, the notification signal line 61 may be used as a signal line for notifying the flash storage device 3 of the update frequency of the write data.

In this case, the controller 4 of the flash storage device 3 checks the value (logical “1” or logical “0”) of the notification signal line 61 using the host interface 11, determines, based on the value of the notification signal line 61, whether or not the write data is data having high update frequency, and selectively writes the write data into a block for data having high update frequency or a block for data having low update frequency, based on the determination.

For example, the host 2 sets the notification signal line 61 to the high level (logical “1”) when data having high update frequency is to be written and sets the notification signal line 61 to the low level (logical “0”) when data having low update frequency is to be written so as to make it possible to notify the flash storage device 3 of whether the write data is data having high update frequency or data having low update frequency.

When the controller 4 receives a write command from the host 2, the controller 4 determines whether the notification signal line 61 is at the high level (logical “1”) or low level (logical “0”). When it is determined that the notification signal line 61 is at the high level (logical “1”), the controller 4 determines that the write data is data having high update frequency. Then, the controller 4 writes the write data into a block for data having high update frequency. In this case, the controller 4 may write the write data into the block for data having high update frequency in the SLC mode.

When it is determined that the notification signal line 61 is at the low level (logical “0”), the controller 4 determines that the write data is data having low update frequency. Then, the controller 4 writes the write data into a block for data having low update frequency. In this case, the controller 4 may write the write data into the block for data having low update frequency in the TLC mode.

### MODIFICATION EXAMPLE

In the first to fourth embodiments described above, a NAND flash memory is given as an example of a nonvolatile memory. However, functions of the respective embodiments can also be applied to other nonvolatile memories such as a magnetoresistive random access memory (MRAM), phase change random access memory (PRAM), resistive random access memory (ReRAM), and ferroelectric random access memory (FeRAM).

In addition, a user may force certain data to be treated as system data by adding the system data tag to such data. Examples of such data to be treated as system data may be data that the user desires to be written in the SLC mode, in memory system configurations where the controller 4 writes the write data into the block for data having high update frequency in the SLC mode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system connectable to a host, comprising:
a nonvolatile memory that includes a plurality of blocks; and
a controller that is electrically connected to the nonvolatile memory,
wherein the controller is configured to determine whether or not write data received from the host has system data characteristics based on tag information received from the host along with the write data, and to:
write first write data designated as data having the system data characteristics according to the received tag information into a first block for writing first type data having a first level update frequency, and
write second write data not designated as data having the system data characteristics according to the received tag information into a second block for writing second type data having a second level update frequency lower than the first level update frequency.

2. The memory system according to claim 1, wherein the first block is a write destination block for data having a size that is less than a threshold size and the second block is a write destination block for data having a size that is greater than or equal to the threshold size.

3. The memory system according to claim 1, wherein the controller is configured to execute data writing into the first block in a first program mode and into the second block in a second program mode that is different from the first program mode.

4. The memory system according to claim 3, wherein the first program mode is a single-level-cell (SLC) program mode.

5. The memory system according to claim 1, wherein the write data having the system data characteristics include one of logs, file system metadata, operating system data, time stamps, and setting parameters.

6. The memory system according to claim 1, wherein the tag information is contained within a write command associated with the write data.

7. The memory system according to claim 6,
wherein the memory system conforms to the universal flash storage (UFS) standard, and
the tag information is specified in a GROUP NUMBER field of a write command of the UFS standard.

8. The memory system according to claim 1,
wherein the memory system conforms to the embedded multimedia card (eMMC) standard, and
the tag information is specified in a SET_BLOCK_COUNT command of the eMMC standard that is issued prior to a write command associated with the write data.

9. A memory system connectable to a host, comprising:
a nonvolatile memory that includes a plurality of blocks; and
a controller that is electrically connected to the nonvolatile memory,
wherein the controller is configured to determine whether or not write data received from the host has system data characteristics, and to:
write first write data designated as data having the system data characteristics into a first block in a first program mode, and
write second write data not designated as data having the system data characteristics into a second block in a second program mode that is different from the first program mode.

10. The memory system according to claim 9, wherein the first block is a write destination block for data having a size that is less than a threshold size and the second block is a write destination block for data having a size that is greater than or equal to the threshold size.

11. The memory system according to claim 9, wherein the first program mode is a single-level-cell (SLC) program mode.

12. The memory system according to claim 9, wherein the write data having the system data characteristics include one of logs, file system metadata, operating system data, time stamps, and setting parameters.

13. The memory system according to claim 9, wherein the controller is configured to determine whether or not write data received from the host has the system data characteristics based on tag information received from the host along with the write data.

14. The memory system according to claim 13, wherein the tag information is contained within a write command associated with the write data.

15. The memory system according to claim 14,
wherein the memory system conforms to the universal flash storage (UFS) standard, and
the tag information is specified in a GROUP NUMBER field of a write command of the UFS standard.

16. The memory system according to claim 13,
wherein the memory system conforms to the embedded multimedia card (eMMC) standard, and
the tag information is specified in a SET_BLOCK_COUNT command of the eMMC standard that is issued prior to a write command associated with the write data.

17. A memory system connectable to a host via an interface conforming to the universal flash storage (UFS) standard, comprising:
a nonvolatile memory that includes a plurality of blocks; and
a controller that is electrically connected to the nonvolatile memory and configured to:
receive, from the host, a write command that includes a GROUP NUMBER field; and
in a case where the GROUP NUMBER field includes a first value, at least one bit of the first value being “1”, write data associated with the write command into a first block in a first program mode.

18. The memory system according to claim 17, wherein the first program mode is a single-level-cell (SLC) program mode.

19. The memory system according to claim 18, wherein the first value is 10000b.

20. The memory system according to claim 17, wherein the controller is further configured to:
in a case where the GROUP NUMBER field does not include the first value, write data associated with the write command into a second block in a second program mode that is different from the first program mode.
